(19) United States
(12) Patent Application Publication
(10) Pub. No.: US 2015/0278339 A1
(43) Pub. Date: Oct. 1, 2015

(54) PERSONALIZED ACTIVITY DATA GATHERING BASED ON MULTI-VARIABLE USER INPUT AND MULTI-DIMENSIONAL SCHEMA

(71) Applicant: Maruthi Siva P Cherukuri, Allston, MA (US)

(72) Inventor: Maruthi Siva P Cherukuri, Allston, MA (US)

(21) Appl. No.: 14/464,620

(22) Filed: Aug. 20, 2014

Related U.S. Application Data
(60) Provisional application No. 61/973,233, filed on Mar. 31, 2014.

(51) Int. Cl. G06F 17/30; H04L 29/08

(52) U.S. Cl. CPC G06F 17/30598; G06F 17/30312; G06F 17/3053; H04L 67/306; G06F 17/30958

(57) ABSTRACT

A personalized activity data retrieval system and method provides users a platform to search activity data based on multi-variable user input. The present invention provides a search method where the system searches a database to gather activity information based on user interests and user attributes. A customization of search results are applied multi-dimensionally to customize the search result based on user interest and user attributes. As such, the search results are personalized to meet the user's search objective. Searches conducted with the same topic can be returned with different results for different users having varying attributes. Search results are more progressive such that they are more usable and the granularity of the customization increases.

### CROSS-REFERENCE TO RELATED APPLICATIONS

This application is a non-provisional application which claims the benefit to Provisional Application No. 61/973,233 filed on Mar. 31, 2014.

### BACKGROUND

1. Field of the Invention

The present invention relates generally to a system and method for gathering or extracting information in a network. More particularly, the present invention relates to system and method for gathering activity data based on a user's interest and attributes. Also, the present invention relates to information management technique and presentation of information. It particularly relates to personalizing information with a multi-dimensional ranking method.

2. Description of Related Art

It is common nowadays to use the Internet as a primary source of information. The amount of information being shared on the internet has seen rapid growth since the emergence of the internet. It is an effective channel of information for a user to search any information needed. As the number of users and amount of information grow, there have been attempts to organize the information and customize the information per user's preference. Most common attempt is to tag information with certain keywords.

Most of the search platforms provide keyword-based searches where results are presented to users based on certain order of relevancy. More often than not, the results of the searches are not customized to accommodate particular needs of each user. Users, having different objectives in searching for the same topic, may receive the same result regardless of the differences in their objectives.

Current search engines do not provide many options to customize how searches are done or how they are presented. When a user searches for an activity or how-to information, keywords are entered and the search is initiated based on the keyword without considering the user's intention for the search. When new information is introduced in the database, a new search needs to be conducted to gather the new information. In addition, users may not be able to gather certain information when the keywords being searched do not match with the information.

Therefore, what is needed is a system and method that provides more usability to a user when gathering information from a network or the Internet and a search result that encompasses user's search objective at a granular level. Also what is needed is a search platform that provides ease of information management and sharing based on multiple users' preferences.

### SUMMARY

The subject matter of this application may involve, in some cases, interrelated products, alternative solutions to a particular problem, and/or a plurality of different uses of a single system or article.

The present invention overcomes the limitations of the prior art by providing a system and method for gathering personalized activity data based on multi-variable user input and multi-dimensional schema.

An object of the present invention is to provide the user with activity data that reflects the user's interests and objectives that may be used to progressively achieve goals and plan activities.

Another objective of the present invention is to provide the user with customized search result that suits the user's search objectives.

Yet another objective of the present invention is to provide a search platform that enables multiple users to collaborate in planning and achieving a group's goals and activities.

Yet another objective of the present invention is to provide the user with an activity graph that enables the users to track progress with the activities planned and to receive suggestions of subsequent activities that are related to the general objective and preference of the user.

Still another objective of the present invention is to provide a searching and ranking of the data based on multi-variable user input and multi-dimensional schema to assign ranking to the search results.

Accordingly, the present invention provides a system and method of gathering activity data based on one or more users' objectives and preferences. The present invention provides a system and method for personalized activity data gathering from an information database, such as the internet.

In one aspect, a method of gathering an activity data based on one or more user profiles is provided. The one or more user profiles may be obtained from one or more users, where each of the one or more user profiles comprises a plurality of user interests and a plurality of user attributes. The method beings with identifying the plurality of user interests and the plurality of user attributes received by one or more computerized user interfaces from each of the one or more users. A plurality of action verbs may be generated from the plurality of user interests. The plurality of action verbs may be obtained from a database schema. The database schema may contain a list of action verbs, where each of the list of action verbs has hierarchical link to at least one of the plurality of user interests.

The method may continue with searching a plurality of base contents based on at least one of the plurality of action verbs. The plurality of base contents may be searched from a database, where the database may be in communication with the internet or a user community. The plurality of base contents may be sorted to identify a portion that contains at least one of the plurality of action verbs, thereby providing a plurality of target contents. The plurality of target contents may be indexed to a plurality of categories, where each of the plurality of categories may be defined by each of the plurality of user attributes. Further, the plurality of categories may be structured with a hierarchical structure defined in the database schema.

A rank may be assigned to each of the plurality of target contents based on a plurality of rank factors. The plurality of rank factors may include: a number of the at least one of the plurality of action verbs within each of the plurality of target contents; a number of the at least one of the plurality of action verbs generated commonly from the one or more user profiles, within each of the plurality of target contents; the hierarchical link associated to the at least one of the plurality of action verbs; a number of the plurality of categories indexed to each of the plurality of target contents; a number of the plurality of categories common to the one or more user profiles, indexed to the plurality of target contents; each of a plurality of user relations, where the database schema contains the plurality of user relations defined among each of the one or more users; the hierarchical structure associated to each of the plurality of categories; and an author's user attributes related to the at least one of the plurality of action verbs.

In another aspect, a non-transitory computer readable medium storing executable instruction is provided. The instruction, when executed, may cause a computer processor to perform the method described above.

In yet another aspect, a system for gathering an activity data for one or more users is provided. The system may comprise user devices, an aggregation module, an action verb generator, a search module, a sorting module, a ranking module, and an activity graph module. The user devices may be in communication with a processor via a network, where each of the one or more users may input one or more user profiles, via one or more user interfaces. The user profiles may comprise a plurality of user interests and a plurality of user attributes.

The aggregation module may identify the plurality of user interests and the plurality of user attributes. The action verb generator may generate a plurality of action verbs based on the plurality of user interests from each of the one or more user profiles. The plurality of action verbs may be obtained from a database schema, where a list of action verbs may be stored. Each of the list of action verbs may have a hierarchical link to at least one of the plurality of user interests. The search module may search within a database for a plurality of base contents based on at least one of the plurality of action verbs. The database may communicate with the internet and a user community.

The sorting module may sort the plurality of base contents to identify a portion that contains at least one of the plurality of action verbs, providing a plurality of target contents. Further, the sorting module may index the plurality of target contents to a plurality of categories, where each of the plurality of categories is defined by each of the plurality of user attributes. The plurality of categories may have a hierarchical structure.

The ranking module may assign a rank to each of the plurality of target contents based on a plurality of rank factors. The plurality of rank factors may include: a number of the at least one of the plurality of action verbs within each of the plurality of target contents; a number of the at least one of the plurality of action verbs generated commonly from the one or more user profiles, within each of the plurality of target contents; the hierarchical link associated to the at least one of the plurality of action verbs; a number of the plurality of categories indexed to each of the plurality of target contents; a number of the plurality of categories common to the one or more user profiles, indexed to the plurality of target contents; each of a plurality of user relations, where the database schema contains the plurality of user relations defined among each of the one or more users; the hierarchical structure associated to each of the plurality of categories; and an author's user attributes related to the at least one of the plurality of action verbs.

The activity graph module may provide to each of the one or more users, the activity data. The activity data may comprise the plurality of target contents prioritized based on the assigned rank. The prioritized plurality of target contents may be displayed by the activity graph module on a time-dependent graph.

Many benefits are achieved by way of the present invention over conventional techniques. For example. The present invention helps users to stay up-to-date with the information they are interested in. The users may manage, plan, and track series of ongoing and upcoming activities. In addition, the present invention enables multiple users to collaborate and share information.

These and other objectives, features and advantages of the present invention will become apparent from the following detailed description of illustrative embodiments thereof, which is to be read in connection with the accompanying drawings.

### BRIEF DESCRIPTION OF THE DRAWINGS

FIG. 1 provides an exemplary schematic diagram of the system for personalized data gathering.

FIG. 2 provides an exemplary embodiment of the method for gathering information.

FIG. 3 provides exemplary steps involved in gathering information based on more than one user's user interest.

FIG. 4 provides an exemplary schematic of aggregating multiple user cards.

FIG. 5 provides a detailed exemplary schematic diagram of the system for personalized activity data gathering.

FIG. 6 provides an exemplary block diagram representing a process of action verb generation.

FIG. 7 provides an exemplary block diagram representing a process of multi user profile aggregation.

FIG. 8 provides an exemplary block diagram representing a process of multi user profile aggregation with a common interest.

FIG. 9 provides an exemplary block diagram representing a process of rank assignment.

FIG. 10 provides an exemplary flow diagram representing a bi-directional relationship between activities and database schema.

FIG. 11 provides an exemplary block diagram representing activity suggestion based on a user goal.

FIG. 12 provides an exemplary block diagram representing user goal suggestion based on activities.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a method for customized data gathering and presentation based on user interests and user attributes. Traditionally, searches are conducted based on keywords and/or tags. The present invention provides a multi-platform search interface which provides traditional instant search query result to activity-focused search result, both reflecting the user's interest and attributes. Multiple user interests, such as “cooking” and “fishing”, may be considered at a single search session while reflecting the results based on a schema that ties multiple variables of the user's input in multiple dimensions.

The system of the present invention may define the scope of the search based on user's interest and attribute. The same keyword may be searched by multiple users, while each having different objectives and scopes of the search in mind. The present method of gathering data utilizes the user interests and user attributes to define the objective and scope of the search. For instance, the user interest in “reading” may be personal or professional, for a personal purpose the system may consider user attributes, such as age and education. For a professional purpose, the system may consider user attributes, such as occupation and annual income. Such linkage between user interests and user attributes may be defined by the schema.

The present system may provide user interfaces in a user's computing device where the user may create multiple profiles including the user interests and user attributes, the multiple profiles may be reflected, collectively or severally, to determine the search objective. List of action verbs are generated based on the user profile by a database schema and from the internet. The database schema stores and builds multi-dimensional relations among the user interest, user attributes, and the action verbs.

Initially, the search result may be found by a search module or a web crawler, then the system may process the search result to parse and present them into appropriate details based on the user interest, user attributes, goals, activities, and the like. Ultimately, the system may provide the same search results differently based on the user profile of each user requesting a search. Each activity from the search result may be ranked in order of ranks. Users may personalize sorting and ranking of the search result by assigning priority to their user interests and user attributes.

The search result may be presented in an activity graph, such as a calendar or a timeline, providing the user with activities from the search result. Such presentation of search result allows the users to manage their schedule of activities on a periodic time basis. The system may inform the user with upcoming activities/available activities based on the user profile. The user may be able to set a goal that encompasses multiple activities and track progress of the activities on the activity graph. The user also may set up alert to be informed with the status of their activities and goals.

The present system may provide a social aspect where multiple users share timelines, activities, and the like. The social element enables collaboration and adds another dimension to the search result ranking. For example, collaboration may be recommended to a user who is interested in music with another user who is interested in concert ticket sales. Such relations between users enable the system to reflect such relations when ranking the search result. When the users collaborate, the database schema stores information of relations and related activities, goals, and action verbs. Each search session would create relations among the action verbs and added to the database schema. Thereby, creating a list of action verbs indexed with multi-dimensional factors.

Commonly, web crawling is an automated and methodical process of gathering information from the Internet. This gathered data is then used by the initiating web crawler or search engine to create an index that can then be searched by a user through a web-based interface.

In the present disclosure, a system for personalized data gathering from the Internet is provided. The system may comprise one or more processors, one or more databases, a web crawler, and one or more programs. The one or more programs may comprise instruction that, when executed, presents a user a search platform that gathers information based on the user profile by employing the methods described herein. Additionally, the above mentioned system may further comprise a network where multiple users may have access thereto using a computing device. The system may be connected to the internet.

The system may comprise one or more computers or computerized elements in communication working together to carry out the different functions of the system. The invention contemplated herein further may comprise non-transitory computer readable media configured to instruct a computer or computers to carry out the steps and functions of the system and method, as described herein.

The computing devices and user devices contemplated herein, may include, but are not limited to, desktop computers, laptop computers, tablet computers, handheld computers, smart phones and other cellular phones, and similar internet enabled mobile devices, digital cameras, a customized computing device configured to specifically carry out the methods contemplated in this disclosure, and the like.

The information and data contemplated herein, may include, but is not limited to text data, image data, audio date, video data, and the like.

A method for personalized data gathering in accordance with the system described above is provided. The system may define a scope of the search based on a user interest. A user may set the user interest which may define the scope of the search being conducted by the system. The user interest may be stored in the one or more databases. In one embodiment, the computing device may provide the user a computerized user interface where a user may have access to define the user interest and user attribute.

The user interest may be of any topics that the user is interested in or any information that the user selects to gather from a search session. The user interest may be a personal interest. By way of example, the user interest may be a hobby such as “pets” or “dogs”. The user interest also may be a professional interest relating to the user's occupation or research. The user interest may have any form of words.

The result may be presented in various ways. In one embodiment, the system may update the result by gathering information periodically. By way of example, the system may gather information of the interest area on a daily, weekly, or hourly, basis. The result may be updated accordingly and presented to the user.

In another embodiment, the system may present only new information to the user. The system may gather information regularly and present to the user only up-to-date information.

In yet another embodiment, the system may present only relevant portion of the gathered information to the user. By way of example, the user may be presented with only the location, time, and the RSVP information of event information.

In a further embodiment, the system may present the user a URL or a raw version of the gathered information without processing them.

Users may provide the user interests and the user attributes through a computerized user interface on a user device. In one embodiment, the user may define the user interest in a user interface called “cards”. The program within the system may provide the user a card as a user interface for the user to define the user interest. Once a user builds the card, it may be linked to another user's card through an aggregation module. The aggregation module aggregates the user interest from both of the cards stored in the system. Multiple users are connected in a network which contains the system. In turn, the information is gathered based on the aggregated user interest.

The card may define not only the user interest of the user, but also may include attributes of the user. The user attribute defines the status of the user. By way of example, the card may include user attributes such as occupation, age, sex, marital status, and the like. The information may be gathered and customized based on the user attributes. In one embodiment, the customization may be the basis to rank the gathered information and presented to the user in order of ranks.

The user may update, manage, create, or change information entered in the card at any time. Such actions made to the card may be identified by the system and the information may be gathered reflecting such actions.

In one embodiment, the user may publish information in the system or the network, thereby introducing new information to one or more users. The published information may be exclusively added to a database separately from the World Wide Web, where only the users within the network may have access to such published information. The system may additionally gather information from the user published information, shared to a user community.

The system for personalized data gathering may implement a social media aspect. In one embodiment, each of the multiple users may publish a log of the activities that the user has conducted. The log may be searchable such that it may be utilized for linking one user to another user, based on the activities being shared or the activities being generated from common user interests or user attributes between the two users.

The following further describes exemplary embodiments of the operational environment and methods for personalized activity data gathering.

A system for personalized activity data gathering is provided. The system presented herein represents a high-level architecture of system components and functions to carry methods presented herein. The system and method disclosed herein may be operable with one or more computing devices. The system may comprise a processor in communication with series of modules within a query server. The series of modules may comprise an aggregation module, an action verb generator, a search module, a sorting module, a ranking module, and a suggestion module. The processor may be in communication with the internet and a database schema. Further, a user may provide user interest and user attribute through a user interest GUI and a user Attribute GUI, respectively, to the query server via a network. A user interface called an activity graph module provides the user with a search result carried by the query server.

The aggregation module may be established with a bi-directional communication channels between the system and the users, where any type of user inputs and system outputs may be collected. The aggregation module may further determine a scope of the search based on the user input and the system outputs. The action verb generator may generate actionable verbs from any words. The action verb also may generate words of any type related to the user input. The search module may process the action verb and gather a base content including activities that conforms to the user input and the scope of the search. The sorting module may examine the base content and identify portion of the base content that matches the user input to provide a plurality of target contents. The ranking module may rank the plurality of target contents. Each of the plurality of target contents may be presented to the user in order of the ranks decided by the ranking module. The ranking module decides the ranks of each of the plurality of target contents by considering rank factors. Finally, a suggestion module may be provided within the system which may suggest foreseeable activities, related activities, goals, guides and alternative search strategies conforming to the scope of the search.

A method of gathering activity data based on user interest and user attribute is provided. The method may be employed by the system disclosed herein.

The method begins with collecting user input. The user input includes a user profile which comprises the user interest and the user attribute. Multiple user interests may be collected by the aggregation module. As such, user interest is a variable that defines the scope of a search. The user interest may be any information, which may include, but are not limited to, personal interest, professional interest, topics, people, and products. The user attributes may be attributes that identify the user. Such attributes may include, but are not limited to, age, health, financial status, sex, marital status, occupation, race, educational background, and the like. The user attributes may be changed. Multiple user attributes may be assigned to the user. Each of the multiple user attributes may be reflected in the method of gathering data either collectively or severally.

In one embodiment, the user may provide the user interest and the user attribute through the user interest GUI and the user attribute GUI where both are in communication with the query server via the network.

In another embodiment, the user may provide a single user interest and multiple user attributes relating to the single user interest. By way of example, the user may provide the single interest, “cooking”, with the multiple user attributes of “Location: Boston” and “Educational background: Culinary school student”. Once the user input is identified, the query server may utilize the provided single user interest and the multiple user attributes to gather personalized activity data.

In yet another embodiment, the user may provide a multiple user interests and a single user attribute.

In a further embodiment, the user may provide a multiple user interest and a multiple user attributes. The user may initiate a search session with the entire user input interrelated to each other or the user may selectively prioritize any combination of the multiple user interests and the multiple user attributes for each search sessions.

In a further embodiment, one user's user interest and user attribute may be combined with another user's user interest and user attribute, thereby aggregating multiple user interest from multiple users. In this embodiment, the one user and another user may be collaboratively search for an activity that is personalized for the two of them.

Once the user interest and the user attribute are collected by the aggregation module, the action verb generator may generate an action verb based on the user interest and/or the user attribute. The action verb generator may determine a scope of the search. Further, the action verb generator may generate a plurality of action verbs based on the user interest.

In one embodiment, the action verb may be obtained from the database schema. The database schema may include a list of action verbs that relates to user interests and user attributes. The database schema may obtain an action verb that is inputted by the user, when the user provides a user interest in a verb form to initiate the search.

In another embodiment, the action verb may be generated from the internet. The database schema may be in further communication with the internet. The search module in communication with the action verb generator may collect the action verb that is related to the user interest.

In yet another embodiment, the action verb may be generated solely based on either the user interest or solely based on the user attribute. Similarly, the action verb may be generated based on both the user interest and the user attribute. Further, the action verb may be generated based on a selection from the plurality of user interests and the plurality of user attributes.

The action verb generator may build a hierarchical link between each of the plurality of action verbs and the user interest/user attribute. As such, the action verb, once generated, may be stored to the database schema with the hierarchical link built to the action verb. By way of example, the action verb generator may generate words such as, “fishing”, “swimming”, and “yachting”, based on the user interest “water sports”. The hierarchical link may be defined among the three words, for example, “swimming” may take higher hierarchy over the word “fishing”, while “yachting” takes lower hierarchy compared to the word “fishing”.

In one embodiment, the hierarchical link built to the action verb with the user interest may be pre-established in the database schema. The database schema contains logic that defines the hierarchical link among the action verbs stored therein.

In another embodiment, the hierarchical link built to the action verb with the user interest may be assigned by the user.

In yet another embodiment, the hierarchical link built to the action verb with the user interest may be learned by the query server from observing the user's search history and web activity.

The database schema may further define relations among multiple users and their corresponding user interests and user attributes. In one embodiment, the relations between multiple users may be established by one of the multiple users initiating a search session. The relations between multiple users may include, but are not limited to, friend, mentor, coworker, or stranger. The one of the multiple users may assign such relations among the multiple users. The relations built among the multiple users may be stored in the database schema, and further be assigned with a value. The value may represent degree of priority of the relations built among the multiple users.

In another embodiment, the relations among the multiple users may be identified by the system from the user's web activity and search history. The web activity or search history may include any relations among the multiple users in a social websites or any other web activities that indicates relations among the multiple users.

Once the action verb is generated, the search module may gather a base content based on the action verb generated by the action verb generator. The base content may comprise of activity data of any type such as, events, concerts, tasks, recipes, and the like. The search module may be in communication with a database storing the base content.

In one embodiment, the base content may be gathered from the internet.

In another embodiment, the base content may be gathered from the database schema. The database schema may be in connection with a user community. The user community may comprise users utilizing the present system and method. The user community may provide information, such as, activities being searched by the users employing the query server, activities being hosted by the users, and activities being planned by the users. Such activities from the user community may be the basis for the base content. In addition, the user community may provide any information published or shared by the users within the user community.

In yet another embodiment, when multiple users are aggregated in a single search session, the base content may be searched based on the plurality of action verbs derived from the multiple users. Similarly, as discussed above, the base content may be based on the plurality of action verbs generated from a single user.

The search module may not gather any base content including a certain action verb. In such case, the action verb generator may provide the user with an alternative action verb that is derived based on the user attributes. In one embodiment, the alternative action verb may be suggested from the user attribute. By way of example, if the search module fails to gather any data related to action verbs: “Barbeque” and “vegetarian cooking” the action verb may initiate a search scope relating to the user's attributes. The suggestion module identifies that one user attribute is “Hobby: fishing”, then the action verb generator may provide alternative action verbs “Barbeque” and “Pescetarian cooking”.

In another embodiment, similar to the action verbs being generated from the database schema, the database schema may contain a list of alternative action verbs linked to one of the plurality of user attributes. In yet another embodiment, the alternative action verb may be suggested from the user community. The users of the query server, the user community, may provide action verbs that are not included in the database schema. The action verbs and alternative action verbs may be identified by the action verb generator and stored within the database schema provided by the use community.

The base content may be further processed through the sorting module and the ranking module. In one embodiment, the sorting module may match the action verb with the base content to identify a portion of the base content that matches the action verb. The base content may include data or information unrelated to the search session. By way of example, a ticket seller's website may include multiple ticket information that is not related to the ticket the user is interested in. Such ticket seller's website is an example of the base content. The portion of the base content that matches the action verb is a target content.

In another embodiment, the sorting module may match a plurality of base contents from different sources to the action verb, identifying a plurality of target contents originating from different base contents.

In a further embodiment, the sorting module may index the plurality of target contents. The plurality of target contents may be compared to a plurality of categories, where the plurality of categories is defined by the user attributes. Each of the plurality of target contents are indexed to assign the plurality of categories, associated to the user attributes, that matches the plurality of target contents. By way of example, the indexing can be conducted by the user attribute “age: 12”. Any of the plurality of target contents that contains age related information may be indexed according to any age information present in the target content. The target content may not be suitable for age of 12, then the category may be assigned as such.

In yet another embodiment, the plurality of categories may have a hierarchical structure defined in the database schema. The database schema may define priority of the categories by applying the hierarchical structure among the plurality of categories. Alternatively, the user may define the hierarchical structure.

In a further embodiment, the sorting module may filter out the plurality of target contents based on user preference. The user may prefer to receive certain type of information. The type of information may include, but are not limited to, Q&A, recipe, event, review, and the like. The type may be tagged to the target content. Similarly, the user may prefer to receive information published by a certain author. The author can be identified from the plurality of target contents, and the plurality of target contents that matches the preferred author may be selectively provided to the user.

The ranking module may further assign rank to the plurality of target contents identified by the sorting module. The ranking module ranks the target content based on rank factors. The rank factor comprises elements that define relations among users, user interests, and user attributes. The rank factors may include the hierarchical link defined among the action verbs and the hierarchical structure defined among the categories. The rank factors and an assignment of rank may be stored in the database schema. The database schema may include relations defined among users, user interest, categories, action verbs, and user attributes.

The rank factors and ranking methods described herein may be selectively combined to create multiple dimensions of ranks. Each permutation of rank factors may be utilized to accommodate varying scopes of a search, thereby providing a multi-dimensional search results. Instead of ranking, the rank factors may be utilized to select information being preferred by the user as well.

In one embodiment, ranks may be assigned based on a number of matches the target content has with the action verb. In this embodiment, the rank factor is link to the number of matches with the action verb. A target content having more number of matches to the action verb may be assigned a higher rank than a target content having less number of matches to the action verb.

In another embodiment, ranks may be assigned based on a number of matches the target content has with the plurality of action verbs. The multiple user interests and the multiple user attributes may have a hierarchical link to each of the plurality of action verbs. The hierarchy of the action verb existing in the target content may contribute to the rank factor of the target content.

In yet another embodiment, the plurality of action verbs generated from multiple users may be common to one or all of the multiple users. Ranks may be assigned higher to the action verb that is most common among the multiple users. User profiles from the multiple users may also have common user interest and user attribute. In this case, the action verb linked to the common user interest and user attribute may be assigned a higher rank. Accordingly, the target content with the action verb linked to the common user interest and user attribute may be assigned a higher rank.

In a further embodiment, ranks may be assigned based on a user attribute of the author of the target content. The author of the target content may have an occupation attribute that is closely linked to the action verb. A higher rank may be assigned to target content belonging to the author. By way of example, the action verb “Italian cooking” belonging to the target content written by an author with user attribute “Occupation: Chef” and “Location: Italy”, would be assigned a higher rank.

In a further embodiment, ranks of the plurality of target contents may be assigned manually by the user.

In a further embodiment, rank factors may include user attributes such as location and time. A higher rank may be assigned to the target content linked to the location common to the user or the time suitable for the user's schedule.

In a further embodiment, the rank factors may include the rating of the target content. Often times, many instructional information are rated by the users who has performed the instructions provided by it.

In a further embodiment, ranks may be assigned based on the values assigned to the relations among multiple users. The action verb generated from the user interest and the user attribute belonging to a user with closer relations among the multiple users may be assigned a higher rank. Similarly, a target content that are common to a multiple users where the multiple users have a closer relations, may be assigned a higher rank. Also, target contents generated from a user where the user's user attribute matches closely to the action verb or topic being searched may be assigned a higher rank. For example, if the action verb is “completing tax return”, the target content generated from a user with a user attribute of “degree: accounting” is assigned a higher rank.

In a further embodiment, ranks may be assigned based on the plurality of categories. A higher number of the plurality of categories indexed to a target content may result in higher rank. Also, the plurality of target contents may be indexed with a category that is common to the multiple users. A number of such categories within the target content can affect the ranks. In addition, the hierarchical structure associated to each of the plurality of categories may affect the ranks.

In a further embodiment, the rank factors may be obtained from logging and observing the user search history or the user web activity.

In a further embodiment, the rank factors may be updated in real-time as the user profile changes. A change in the user attribute “location” may be reflected to the ranks being assigned to the action verb prior to the change. Similarly, ranks may reflect a change in the user attribute “time”. As the user progresses with the personalized activity data generated by the system, the user may have time constraints in duration of the activity or start time of the activity. By way of example, ranks assigned to the target content of a recipe that requires longer duration may be assigned a lower rank, if the user has conflicting personalized activity data, such as a concert scheduled in the user's timeline or activity graph.

The activity graph module may provide the user with a user interface that presents the target content in a time line, thereby presenting the user with the activity data. By way of example, the target content may be presented as a to-do-list. The activity graph module may include the activity data which is the target content, personalized by the method disclosed herein. Each of the plurality of target contents may be presented to the user in the activity graph module in order or ranks assigned by the ranking module. The user may select one or more of the plurality of target contents to be presented in the activity graph module.

In one embodiment, the user may indicate one or more of the plurality of target contents that the user intends to achieve. Such user indication may be reflected in the database schema and may be linked to the sorting module and the ranking module for assignment of ranks.

In another embodiment, the activity graph module may include a plurality of target contents generated by multiple users. The multiple users of the target content may assign each of the target contents to one or more the multiple users to be achieved. This embodiment may be employed when the plurality of target contents represents a series of personalized activities to be achieved in a step-by-step fashion.

The user interest and the user attribute may be utilized for generating targeted marking and advertisement. Similar to the methods described above, the user may be a merchant who may suggest his or her product to another user based on another user's user interests, user attributes, action verb, and ranks. Such suggestion may be prompted by the suggestion module.

The suggestion module may provide the user with alternative options. The system of the present invention may not provide the user with any target contents. The action verb of the search scope may not have any corresponding target content. Including such case, and any other cases, may require the suggestion module to provide the user with alternative options in a search session.

In one embodiment, an alternative action verb may be provided by the suggestion module. The suggestion module may identify the alternative action verb based on the user attributes, where the database schema contains a list of alternative action verbs. Similar to the action verbs, the alternative action verbs may have a hierarchical link defined among the alternative action verbs in relation to the user attributes.

In another embodiment, the suggestion module may provide a foreseeable activity based on a plurality of related action verbs. The foreseeable activity may be generated by running a search session utilizing the method disclosed herein based on the plurality of related action verbs. The related action verbs may be searched when the action verbs itself does not return any target content back. As such, the plurality of action verbs is different from the plurality of action verbs.

In a further embodiment, a user goal may be suggested by the suggestion module. The suggestion module may identify the user goal from the activity data or the plurality of target contents being provided to the user. The user goal may be the result that may be achievable by the user completing the activity data presented in the plurality of target contents. The database schema may define a series of activities that can be performed by a user to achieve a user goal. The suggestion module may suggest a user goal based on a series of action verbs being searched by the search module. The database schema may store action verbs relating to the user goal and link them together.

The suggestion module may provide the users with various types of alerts.

In one embodiment, the suggestion module may alert the user when a new activity data is introduced to the database schema, which links to the user's user interest, user attribute, or action verb.

In another embodiment, the suggestion module may alert the user when another user having a relation built to the user is hosting an activity.

In a further embodiment, the user interest may be in the form of a user goal. A series of action verbs may be generated by the action verb generator to achieve the user goal, and suggested by the suggestion module to the user. Once the user indicates that the user interest is the user goal, ranks being assigned to the target content of the series of action verbs may be higher. As described above, the target content including the series of action verbs may be presented in the activity graph module. The user may track the progress of the user goal with the activity graph module.

The suggestion module may provide the user with a guide. The guide is a user within the user community that may be well versed with the action verb or any topic being searched by another user. In one embodiment, the guide may be suggested to the user based on the user interest. The guide having a user attribute that is closely related to the user interest being searched may be identified by the suggestion module. For example, if the user searches are related to “building a birdhouse”, a guide with an attribute “hobby: birdhouse design may be identified and suggested to the user. The user, then, may contact the guide within the user community for personal help. In another embodiment, the user may selectively initiate a search session to identify the guide.

In yet another embodiment, the guide may be an author providing information to the user community. The user may initiate a search session to identify information published by the author or the guide.

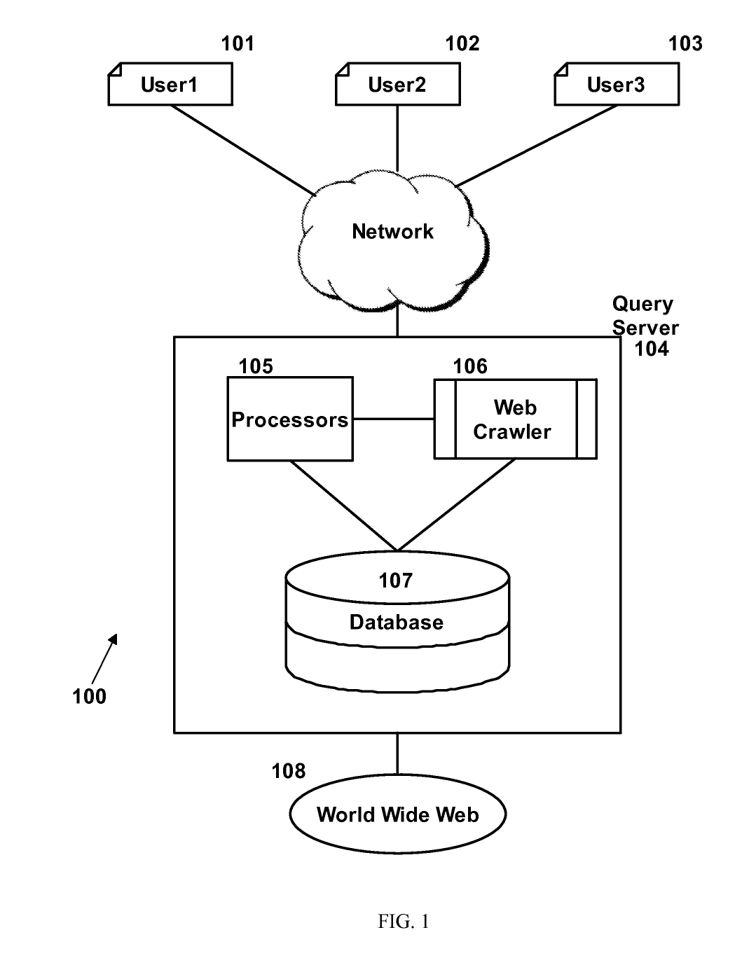

Turning now to FIG. 1, an exemplary schematic diagram of the system for personalized data gathering is shown. The system 100 may comprise multiple users 101 102 103 where each of the multiple users are connected to the network. The query server 104 may comprise a processor 105, a web crawler 106, and a database 107. The query server 104 is in communication with the network. The query server may further communicate with the World Wide Web 108. In this exemplary embodiment, one or more users input, such as interests and attributes are aggregated and searched for in the internet.

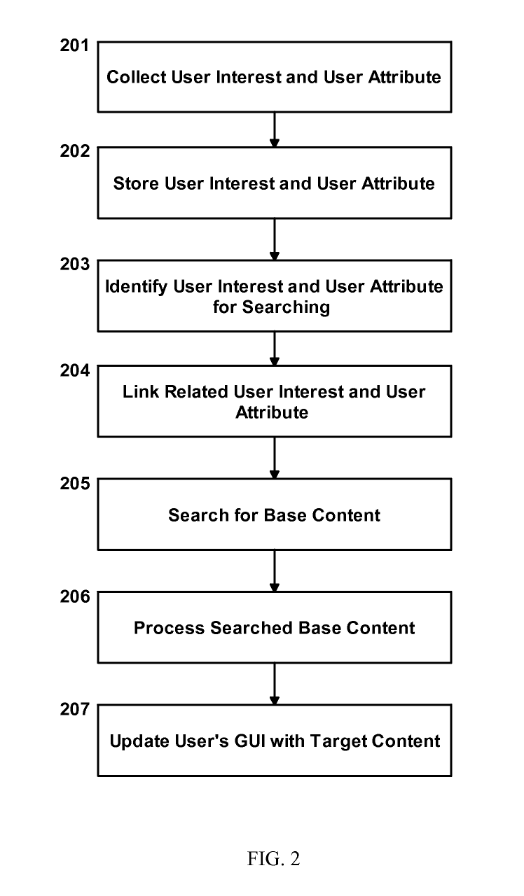

FIG. 2 shows an embodiment of the method for gathering target content. At step 201, the user interest and the user attribute are collected by the system. The system stores the user interest and the user attribute to the database schema 202. The user interest and the user attribute may be recorded in the form of the card as discussed above. For the search or gathering of personalized activity data to begin, the system identifies the user interest and the user attribute at step 203. The action verb generator may link related user interest and user attributes to build hierarchical link among the user interests and the user attributes 204. The search module then searches for the base content based on the user interest and the user attribute 205. The search result may be further processed 206 through the ranking module and the sorting module. At 207, the system may update user interfaces (the activity graph module) with the search result that is personalized.

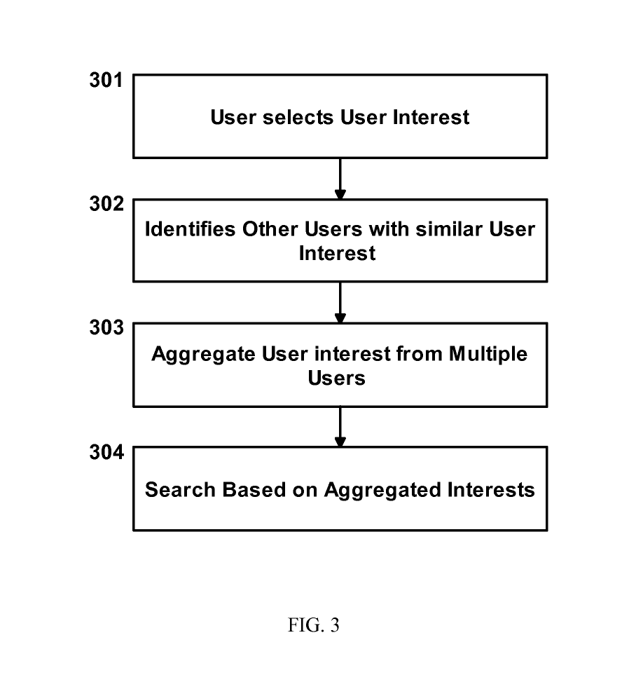

FIG. 3 illustrates steps involved in gathering information based on more than one user's user interest. A user selects the user interest at 301. The system further identifies another user's user interest and links them to the user. At 302, another user's similar user interest is identified and linked to the user's user interest and aggregated at step 303. Activity data is then gathered based on the aggregated user interest from multiple users 304. Thereby, providing the activity data conforming to the search objectives of both the users.

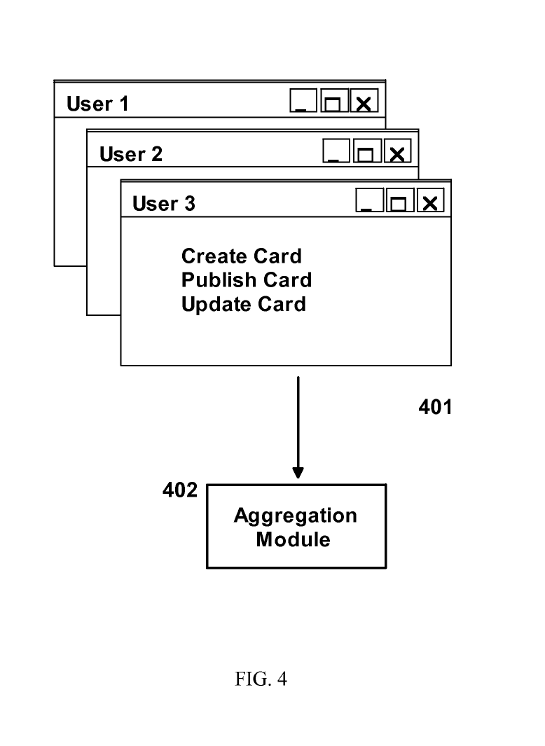

FIG. 4 shows an exemplary schematic of aggregating multiple user cards. The cards 401 may be created by each user. Each user may also update the information of the card, particularly the user interest may be updated. The card may be utilized to publish information from the user. Multiple users' cards 401 may be aggregated once requested by the user or automatically by the system based on the similarities among the user profiles. Once the cards are linked together by the aggregation module 402, information may be gathered based on the aggregation module. The aggregation module aggregates the user interests from the cards 401 stored in the system.

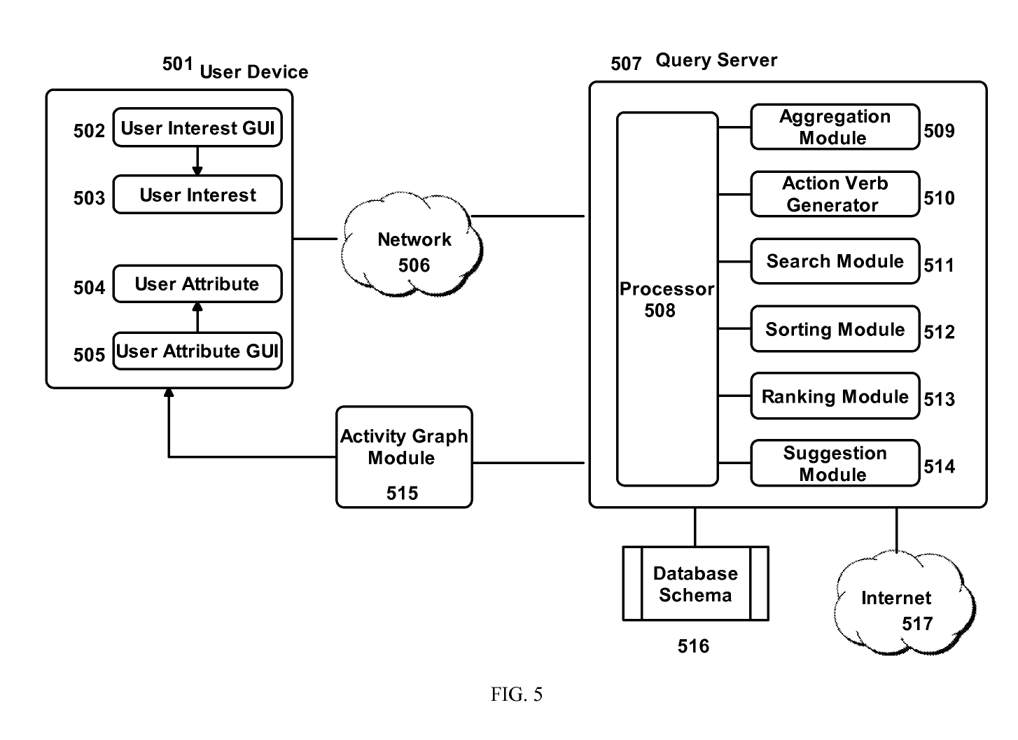

FIG. 5 provides a detailed exemplary schematic diagram of the system components and its design for personalized activity data gathering. The user device 501 provides the user interest GUI 502 for the user to input the user interest 503. The user device 501 also provides the user attribute GUI 505 for the user to input the user attribute 504. The user device 501 is in communication with the query server 507 via a network 506. The query server 507 comprises a processor 508 linked to a multiple modules for generating a personalized activity data. The multiple modules comprise the aggregation module 509, the action verb generator 510, the search module 511, the sorting module 512, the ranking module 513, and the suggestion module 514. The query server is in further communication with the database schema 516 and the internet 517. The activity graph module 515 provides the user with the activity data personalized by the process performed by the query server.

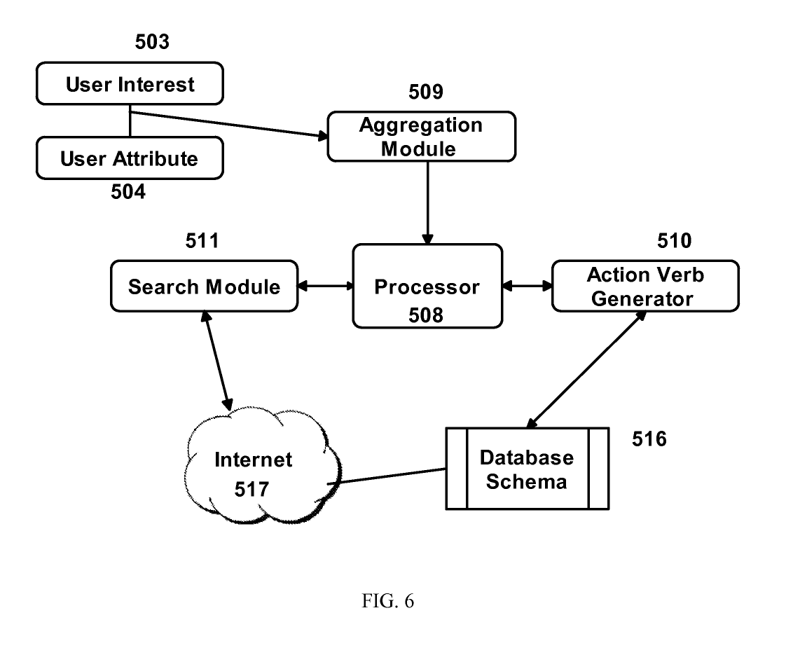

FIG. 6 provides an exemplary block diagram representing a process of action verb generation. The action verb generator 510 receives the user interest 503 and the user attribute 504 collected by the aggregation module 509. The action verb generator 510 generates action verbs relating to the user interest and the user attribute from the internet 517 and the database schema 516. The action verb generated by the action verb generator 510 is searched by the search module 511 where the search module 511 gathers the base content from the internet 517 and the database schema 516.

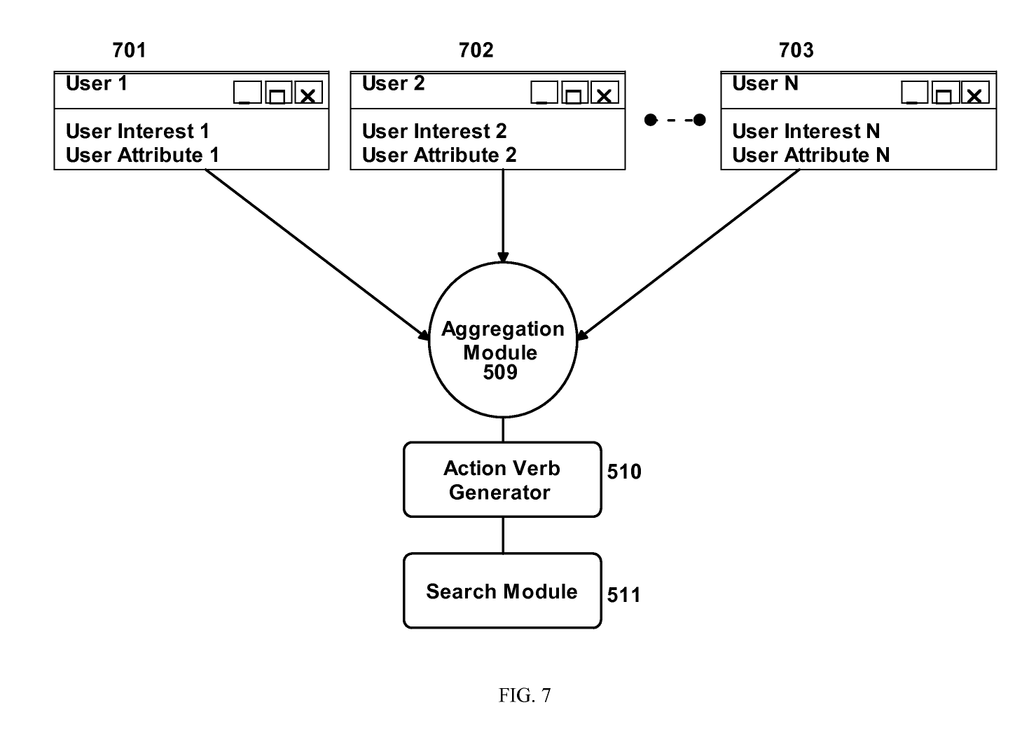

FIG. 7 provides an exemplary block diagram representing a process of multi-user profile aggregation. The multiple users 701 703 704 each are provided with multiple user interests and multiple attributes. The aggregation module 509 collects the multiple user interests and multiple attributes from the multiple users. Once collected, the action verb generator 510 generates one or more action verbs based on the input provided by the multiple users. The generated one or more action verbs are searched by the search module 511 to begin a search session for the multiple users.

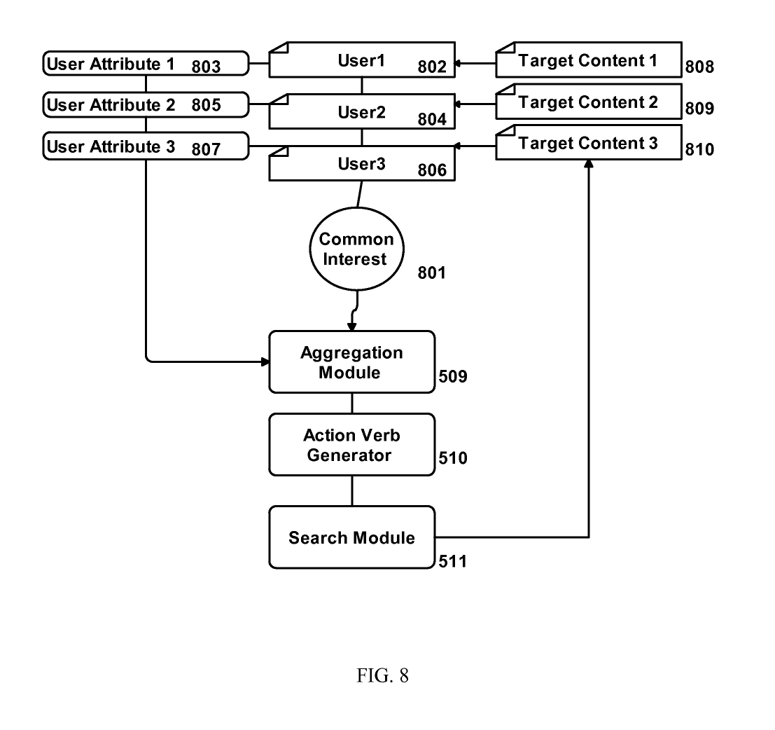

FIG. 8 provides an exemplary block diagram representing a process of multi user profile aggregation with a common interest. This exemplary embodiment shows a search session where multiple users share a common interest, while each of them has varying user attributes. The multiple users 802 804 806 may have a common interest 801. On the other hand, the multiple users may have varying user attributes 803 805 807. The aggregation module 509 identifies the common interest and the varying user attributes 803 805 807. Once identified, the action verb generator 510 generates action verbs based on the common interest. The base contents may be the same for each of the multiple users, while the base contents are tailored to deliver varying target contents to each of the multiple users, based on the varying user attributes. The search module 511 initiates the search for each of the multiple users and present the target contents 808 809 810 (sorting module and ranking module not shown). The target content for each of the multiple users may vary but share the same base content. As discussed above, target contents belonging to the same base content may vary from each other because of the varying attributes affecting the rank factors. Also, indexing the target contents to categories defined by user attributes decide which target content is being presented to each user.

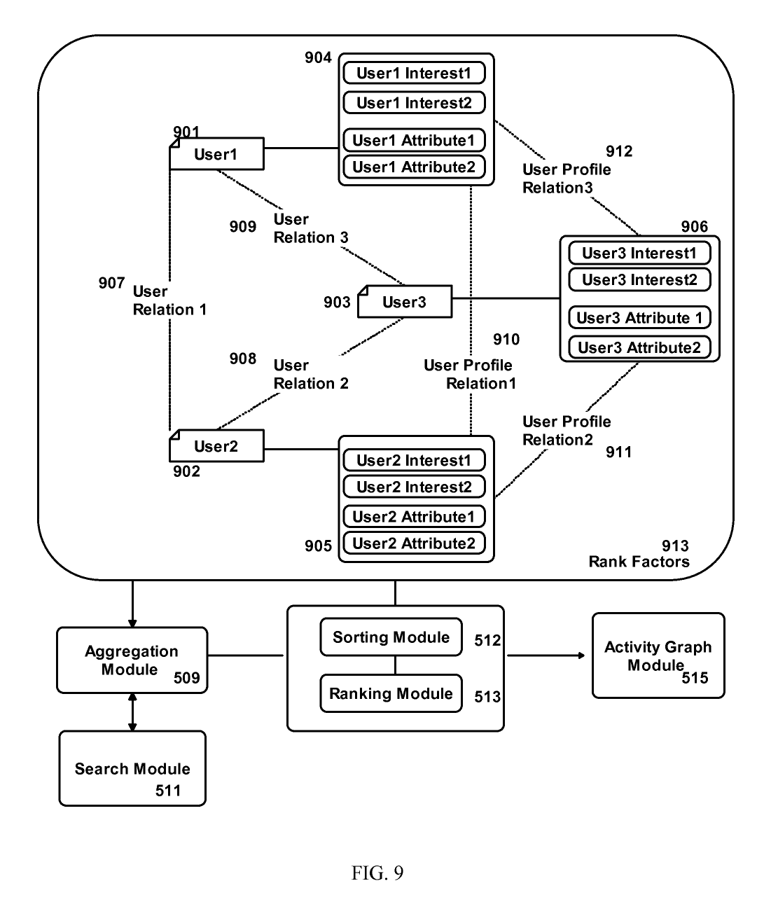

FIG. 9 provides an exemplary block diagram of rank assignment based on rank factors. In this exemplary embodiment, three users 901 902 903 each has two user interest and two user attributes 904 905 906 begins a search session to find an activity data suitable for the three users. The aggregation module 509 gathers the user interests and user attributes and searches for the plurality of base contents via the search module 511. A plurality of action verbs are generated by the action verb generator (not shown), which sets the scope of the search. The plurality of base contents searched by the search module 511 may be sorted and ranked by the sorting module 512 and the ranking module 513. In this example, the sorting module may match the user interests-generated action verbs with the plurality of base contents to identify a plurality of target contents. The ranking module ranks the plurality of target contents based on the rank factors. The rank factors of this example comprise a user relation 1 907, user relation 2 908, user relation 3 909, user profile relation 1 910, user profile relation 2 911, and user profile relation 3 912. The user relations define relationships among each of the three users. The closer or more relevant the relationship is the higher the rank is. Similarly, the similarity and the relevancy among each of the three user profile relations determines the strength of the rank factors user profile relation 1, user profile relation 2, and user profile relation 3. The similarity and the relevancy among each of the three user profile relations reflect multiple ranking permutations described above. In one aspect, the user profile relations may identify a common user interest being shared by the three users. The common user interest may be ranked higher and a target content with the most number of common user interest-based action verbs may be presented to the three users. In another aspect, a common user attribute-based category assigned to each of the plurality of target contents is prioritized. Once the ranks are assigned to each of the plurality of target contents, the activity graph module 515 presents the target contents in order based on the ranks assigned by the ranking module 513.

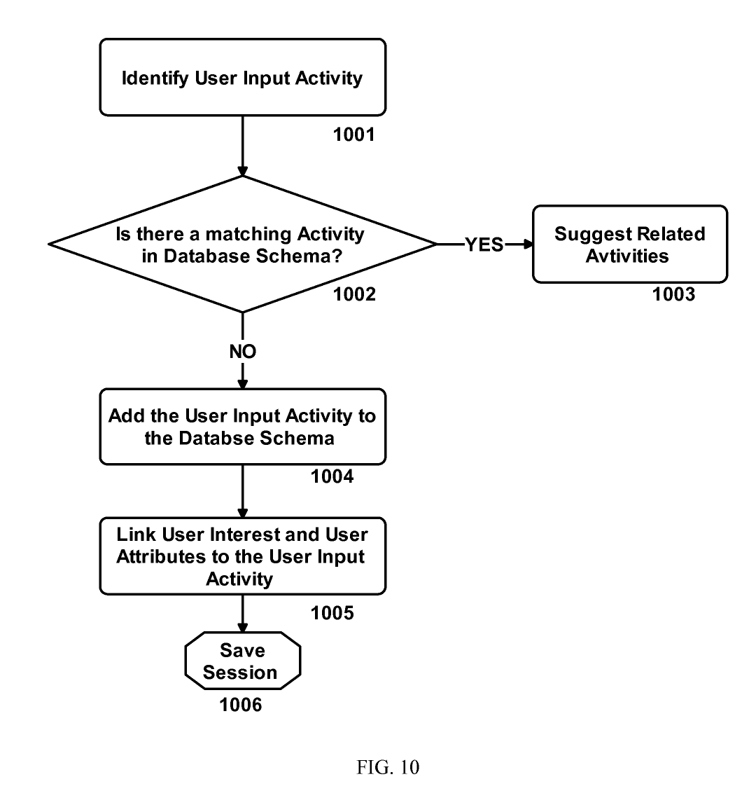

FIG. 10 provides an exemplary flow diagram representing a bi-directional relationship between activities and database schema. The bi-directional relationship is established when activities inputted by the user as the user interest are stored within the database schema. In this example, a user input activity is identified by the system 1001. Once the user inputs the user input activity through the user device, the user input activity is searched within the database schema for a match 1002. When there is a match, the suggestion module suggests activities related to the user input activity at 1003. When there is no match in the database schema, this indicates that the user input activity is new to the system. Subsequently, the user input activity is added to the database schema. The database schema has built a new relation among the user input activity and the user's user profile by linking user interest and user attributes to the user input activity from the user 1005. The search session is saved to the database schema 1006 for future use.

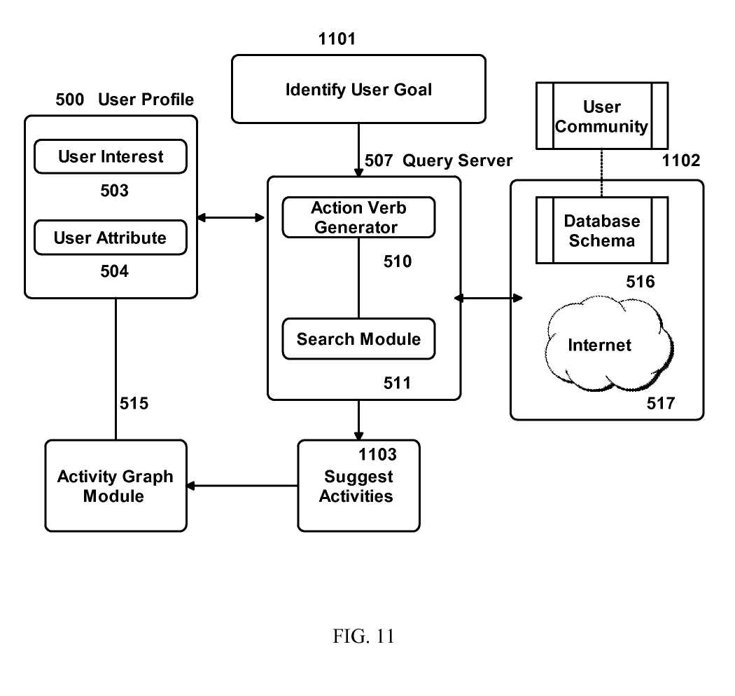

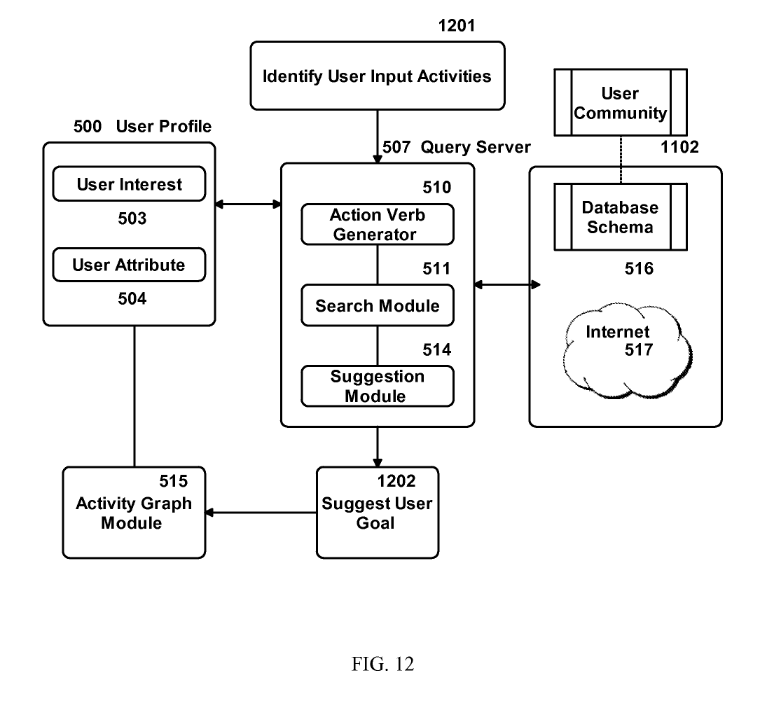

FIG. 11 provides an exemplary block diagram representing user goal to activity suggestion. And FIG. 12 provides an exemplary block diagram representing user goal suggestion from activities. In FIG. 11, the user goal is inputted by the user as the user interest. Once the user indicates the user interest as the user goal, the system identifies the user goal 1101. Similar to a search sequence described above, the query server 507 processes the user goal through the action verb generator 510 and the search module 511 to suggest activities 1103 conforming to the user goal. The activities being suggested may be obtained from the internet 517, the database schema 516, or the user community 1102. The user profile 500 is considered to suggest a series of activities most relevant to the user interest 503 and the user attribute 504 of the user. The action graph module 515 present the user with the series of suggested activities 1103.

Similarly, the user goal input may be replaced with the user input activities 1201 of FIG. 12. In this example, instead of searching for activities to suggest, the suggestion module identifies a user goal to suggest to the user 1202. Once the action verb is generated from the user input activities 1201, the action verb is consulted with the user community, database schema, and the internet to suggest the user goal most relevant to the user interest and the user attribute. The user goal being suggested is presented via the activity graph module 515.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. A method of gathering an activity data based on one or more user profiles, from one or more users, wherein each of the one or more user profiles comprises a plurality of user interests and a plurality of user attributes, the method comprising the steps of:
identifying the plurality of user interests and the plurality of user attributes, accessible by at least one computer, wherein the one or more user profiles are received by one or more computerized user interfaces accessible by each of the one or more users;
generating, by the at least one computer, a plurality of action verbs based on the plurality of user interests from each of the one or more user profiles, the plurality of action verbs being obtained from a database schema, wherein the database schema contains a list of action verbs, each of the list of action verbs having a hierarchical link to at least one of the plurality of user interests;
searching, by the at least one computer, a plurality of base contents based on at least one of the plurality of action verbs, the plurality of base contents being searched from a database, wherein the database is in communication with at least one of: the internet and a user community;
sorting, by the at least one computer, the plurality of base contents, wherein each of the plurality of base contents is examined to identify a portion that contains at least one of the plurality of action verbs, to provide a plurality of target contents;
indexing, by the at least one computer, the plurality of target contents to a plurality of categories, wherein each of the plurality of categories is defined by each of the plurality of user attributes, the plurality of categories having a hierarchical structure defined in the database schema; and
assigning, by the at least one computer, a rank to each of the plurality of target contents, the rank being assigned based on a plurality of rank factors, wherein the plurality of rank factors are selected from the group consisting of:
a number of the at least one of the plurality of action verbs within each of the plurality of target contents;
a number of the at least one of the plurality of action verbs generated commonly from the one or more user profiles, within each of the plurality of target contents;
the hierarchical link associated to the at least one of the plurality of action verbs;
a number of the plurality of categories indexed to each of the plurality of target contents;
a number of the plurality of categories common to the one or more user profiles, indexed to the plurality of target contents;
each of a plurality of user relations, wherein the database schema contains the plurality of user relations defined among each of the one or more users;
the hierarchical structure associated to each of the plurality of categories; and
an author's user attributes related to the at least one of the plurality of action verbs, wherein the author is an owner of at least one of the plurality of target contents.

2. The method of claim 1, wherein one of the one or more users defines one or more of: the rank, the rank factors, the hierarchical link, each of the plurality of user relations, and the hierarchical structure.

3. The method of claim 1, wherein the step of identifying the plurality of user interests and the plurality of user attributes comprises, identifying a single user interest and the plurality of user attributes from each of the one or more users.

4. The method of claim 1, wherein the step of identifying the plurality of user interests and the plurality of user attributes comprises, identifying the plurality of user interests and a single user attribute from each of the one or more users.

5. The method of claim 1, wherein the hierarchical link, the hierarchical structure, and each of the plurality of user relations are learned, by the at least one computer, by logging each of the one or more users' search history and web activity.

6. The method of claim 1, wherein the step of generating, by the at least one computer, a plurality of action verbs based on the plurality of user interests comprises obtaining the plurality of action verbs directly from the one or more users.

7. The method of claim 1, wherein the plurality of categories comprise location and time.

8. The method of claim 1, wherein the author's user attributes is an occupation.

9. The method of claim 1, wherein the step of generating a plurality of action verbs based on the plurality of user interests comprises generating, by the at least one computer, an alternative action verb based on the plurality of user attributes, the alternative action verb being obtained from the database schema, wherein the database schema contains a list of alternative action verbs, each of the list of alternative action verbs having a hierarchical link to at least one of the plurality of user attributes, wherein the alternative action verb is different from the plurality of action verbs, the activity data comprising the alternative action verb.

10. The method of claim 1, further comprising the step of: suggesting, by the at least one computer, a foreseeable activity based on a plurality of related action verbs, wherein the plurality of related action verbs are gathered from the plurality of target contents, the plurality of related action verbs being different from the plurality of action verbs, the activity data comprising the foreseeable activity.

11. The method of claim 1, further comprising the step of: suggesting, by the at least one computer, a user goal, wherein the user goal is identified based on the plurality of target contents, the user goal being achievable by the one or more users completing the activity data presented in the plurality of target contents, the activity data comprising the user goal.

12. The method of claim 1, further comprising the step of: suggesting, by the at least one computer, a guide, wherein the guide is a user within the user community, the guide being identified based on user attributes of the guide, the user attributes of the guide being related to the at least one of the plurality of action verbs.

13. The method of claim 1, further comprising the step of: identifying, by the at least one computer, a type of each of the plurality of target contents, wherein the type is indicated by the author;
receiving from the one or more users, by the at least one computer, the type being preferred by the one or more users; and
selecting, by the at least one computer, the plurality of target contents that matches the type being preferred by the one or more users.

14. The method of claim 1, further comprising the step of: identifying, by the at least one computer, the author of each of the plurality of target contents;
receiving from the one or more users, by the at least one computer, the author being preferred by the one or more users; and
selecting, by the at least one computer, from the plurality of target contents that matches the author being preferred by the one or more users.

15. The method of claim 1, further comprising the step of: providing to a user, by the at least one computer, the activity data, wherein the activity data comprises the plurality of target contents, the plurality of target contents prioritized based on the assigned rank, wherein the prioritized plurality of target contents are provided to the one or more users through the one or more computerized user interfaces, the computerized user interface displaying the prioritized plurality of target contents on a time-dependent graph.

16. The method of claim 1, wherein the plurality of user interests is a user goal, wherein the step of assigning, by the at least one computer, a rank to each of the plurality of target contents comprises assigning a rank to each of the plurality of target contents in an time-dependent manner, such that each of the plurality of target contents are ranked in a step-by-step order, to complete the user goal by each of the one or more users completing the activity data, either collaboratively or individually, presented in each of the plurality of target contents in sequence of the step-by-step order.

17. A non-transitory computer readable medium storing executable instructions which, when executed, cause at least one computer processor to perform the following steps for gathering an activity data based on one or more user profiles from one or more users, wherein each of the one or more user profiles comprises a plurality of user interests and a plurality of user attributes, the steps comprising:
identifying the plurality of user interests and the plurality of user attributes, accessible by at least one computer, wherein each of the one or more user profiles is received by one or more computerized user interfaces accessible by each of the one or more users;
generating, by the at least one computer, a plurality of action verbs based on the plurality of user interests from each of the one or more user profiles, the plurality of action verbs being obtained from a database schema, wherein the database schema contains a list of action verbs, each of the list of action verbs having a hierarchical link to at least one of the plurality of user interests;
searching, by the at least one computer, a plurality of base contents based on at least one of the plurality of action verbs, the plurality of base contents being searched from a database, wherein the database is in communication with at least one of: the internet and a user community;
sorting, by the at least one computer, the plurality of base contents, wherein each of the plurality of base contents is examined to identify a portion that contains at least one of the plurality of action verbs, to provide a plurality of target contents;
indexing, by the at least one computer, the plurality of target contents to a plurality of categories, wherein each of the plurality of categories is defined by each of the plurality of user attributes, the plurality of categories having a hierarchical structure;
assigning, by the at least one computer, a rank to each of the plurality of target contents, the rank being assigned based on a plurality of rank factors, wherein the plurality of rank factors are selected from the group consisting of:
a number of the at least one of the plurality of action verbs within each of the plurality of target contents;
a number of the at least one of the plurality of action verbs generated commonly from the one or more user profiles, within each of the plurality of target contents, within each of the plurality of target contents;
the hierarchical link associated to the at least one of the plurality of action verbs;
a number of the plurality of categories indexed to each of the plurality of target contents;
a number of the plurality of categories common to the one or more user profiles, indexed to the plurality of target contents;
each of a plurality of user relations, wherein the database schema contains the plurality of user relations defined among each of the one or more users;
the hierarchical structure associated to each of the plurality of categories; and
an author's user attributes related to the at least one of the plurality of action verbs, wherein the author is an owner of at least one of the plurality of target contents;
suggesting, by the at least one computer, a foreseeable activity based on a plurality of related action verbs, wherein the plurality of related action verbs are gathered from the plurality of target contents, the plurality of related action verbs being different from the plurality of action verbs, the activity data comprising the foreseeable activity; and
providing to each of the one or more users, by the at least one computer, the activity data, wherein the activity data further comprises the plurality of target contents, the plurality of target contents prioritized based on the assigned rank, wherein the prioritized plurality of target contents are provided to each of the one or more users through a computerized user interface, the computerized user interface displaying the prioritized plurality of target contents on a time-dependent graph.

18. A system for gathering an activity data for a one or more users, comprising:
a multiple computerized user devices, each having a user interface, in communication with a processor via a network, wherein each of the multiple computerized user devices is capable of receiving a one or more user profiles from each of the one or more users, wherein each of the one or more user profiles comprises a plurality of user interests and a plurality of user attributes;
an aggregation module, in communication with the processor, capable of identifying the plurality of user interests and the plurality of user attributes;
an action verb generator, in communication with the processor, capable of generating a plurality of action verbs based on the plurality of user interests from each of the one or more user profiles, the plurality of action verbs being obtained from a database schema, wherein the database schema contains a list of action verbs, each of the list of action verbs having a hierarchical link to at least one of the plurality of user interests;
a search module, in communication with the processor, capable of searching a plurality of base contents based on at least one of the plurality of action verbs, the plurality of base contents being searched from a database, wherein the database is in communication with at least one of: the internet and a user community;
a sorting module, in communication with the processor, capable of sorting the plurality of base contents, wherein each of the plurality of base contents is examined to identify a portion that contains at least one of the plurality of action verbs, to provide a plurality of target contents, the sorting module further capable of indexing the plurality of target contents to a plurality of categories, wherein each of the plurality of categories is defined by each of the plurality of user attributes, the plurality of categories having a hierarchical structure;
a ranking module, in communication with the processor, capable of assigning a rank to each of the plurality of target contents, the rank being assigned based on a plurality of rank factors, wherein the plurality of rank factors are selected from the group consisting of:
a number of the at least one of the plurality of action verbs within each of the plurality of target contents;
a number of the at least one of the plurality of action verbs generated commonly from the one or more user profiles, within each of the plurality of target contents, within each of the plurality of target contents;
the hierarchical link associated to the at least one of the plurality of action verbs;
a number of the plurality of categories indexed to each of the plurality of target contents;
a number of the plurality of categories indexed commonly to the plurality of target contents;
each of a plurality of user relations, wherein the database schema contains the plurality of user relations defined among each of the one or more users;
the hierarchical structure associated to each of the plurality of categories; and
an author's user attributes related to the at least one of the plurality of action verbs, wherein the author is an owner of at least one of the plurality of target contents; and
an activity graph module, in communication with the processor, in further communication with each of the multiple computerized user devices, capable of providing to each of the one or more users, the activity data, wherein the activity data comprises the plurality of target contents, the plurality of target contents prioritized based on the assigned rank, wherein the prioritized plurality of target contents are provided to each of the one or more users through a computerized user interface, the computerized user interface displaying the prioritized plurality of target contents on a time-dependent graph.

19. The system of claim 18, further comprising a suggestion module, in communication with the processor, capable of suggesting a foreseeable activity based on a plurality of related action verbs, wherein the plurality of related action verbs are gathered from the plurality of target contents, the plurality of related action verbs being different from the plurality of action verbs, the activity data comprising the foreseeable activity.

20. The system of claim 18, wherein the multiple computerized user devices is further capable of receiving one or more of: the rank, the rank factors, the hierarchical structure, each of the plurality of user relations, and the hierarchical link, from one of the one or more users.

21. The system of claim 18, wherein the hierarchical link, the hierarchical structure, and each of the plurality of user relations are defined, by the action verb generator, by logging each of the one or more users' search history and web activity.

22. The system of claim 19, wherein the suggestion module is further capable of suggesting a user goal, wherein the user goal is identified based on the plurality of target contents, the user goal being achievable by each of the one or more users completing the activity data presented in the plurality of target contents, the activity data comprising the user goal.

23. The system of claim 18, wherein the action verb generator is further capable of generating an alternative action verb based on the plurality of user attributes, the alternative action verb being obtained from the database schema, wherein the database schema contains a list of alternative action verbs, each of the list of alternative action verbs having a hierarchical link to at least one of the plurality of user attributes, wherein the alternative action verb is different from the plurality of action verbs, the activity data comprising the alternative action verb.

24. The system of claim 18, wherein the ranking module is further capable of assigning a rank to each of the plurality of target contents in an time-dependent manner, such that each of the plurality of target contents are ranked in a step-by-step order, to complete a user goal by each of the one or more users completing the activity data, either collaboratively or individually, presented in each of the plurality of target contents in sequence of the step-by-step order.
